(19) United States
(12) Patent Application Publication
(10) Pub. No.: US 2008/0047388 A1
(43) Pub. Date: Feb. 28, 2008

(54) SAFETY THROTTLE CONTROL APPARATUS

(76) Inventor: Michel LACHANCE, Edmonton (CA)

Correspondence Address: DAVIS BUJOLD & Daniels, P.L.L.C., 112 PLEASANT STREET, CONCORD, NH, 03301, US

(21) Appl. No.: 11/829,389

(22) Filed: Jul. 27, 2007

(30) Foreign Application Priority Data
Aug. 22, 2006 (CA) 2557949

(51) Int. Cl. G05G 1/04

(52) U.S. Cl. 74/526; 74/491

(57) ABSTRACT

A safety throttle control for an AVT includes a switch on a handle of an ATV. The handle of the ATV is adjacent to a throttle trigger. The throttle trigger is in an inoperative idling position unless pressure is concurrently applied to the switch and the throttle trigger.

### FIELD

The present application relates to a safety throttle control apparatus for preventing the accidental acceleration of an ATV.

### BACKGROUND

Safety devices for controlling the top speed of ATVs have been taught, such as U.S. Pat. No. 3,688,599 (St. Germain), or for locking a control lever, such as U.S. Pat. No. 5,347,835 (Dewey).

### SUMMARY

There is provided a safety throttle control for an AVT includes a switch on a handle of an ATV. The handle of the ATV is adjacent to a throttle trigger. The throttle trigger is in an inoperative idling position unless pressure is concurrently applied to the switch and the throttle trigger.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a top plan view, in partial section, of an ATV handle with a safety throttle control in the idle lock position.

FIG. 2 is a top plan view, in partial section, of an ATV handle with a safety throttle control in the operative throttle position.

FIG. 3 is a detailed side elevation view, in section, of a safety throttle control in the idle lock position.

FIG. 4 is a detailed side elevation view, in section, of a safety throttle control in the operative throttle position.

FIG. 5 is a detailed top plan view, in section, of a shaft and actuator in the idle lock position.

FIG. 6 is a detailed top plan view, in section, of a shaft and actuator in the operative throttle position.

FIG. 7 is a detailed top plan view, in section, of a shaft and actuator in the operative throttle position.

FIG. 8 is a side elevation view, in section, of an alternative safety throttle control in the idle lock position.

FIG. 9 is a side elevation view, in section, of an alternative safety throttle control in the operative throttle position.

### DETAILED DESCRIPTION

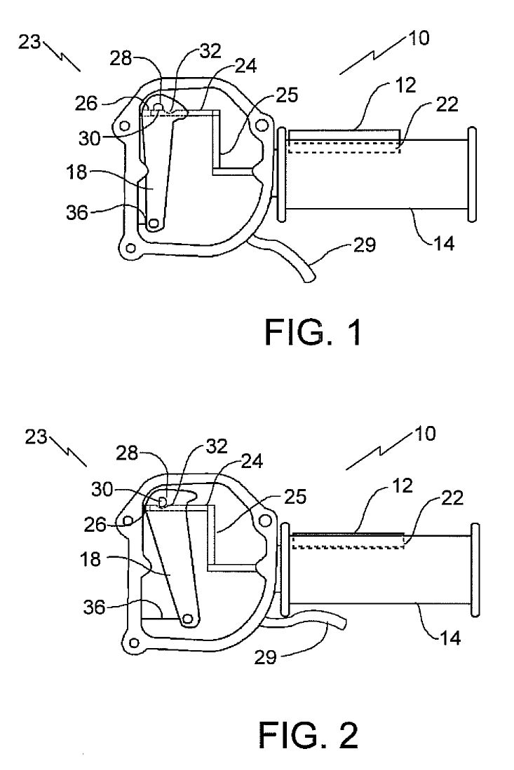

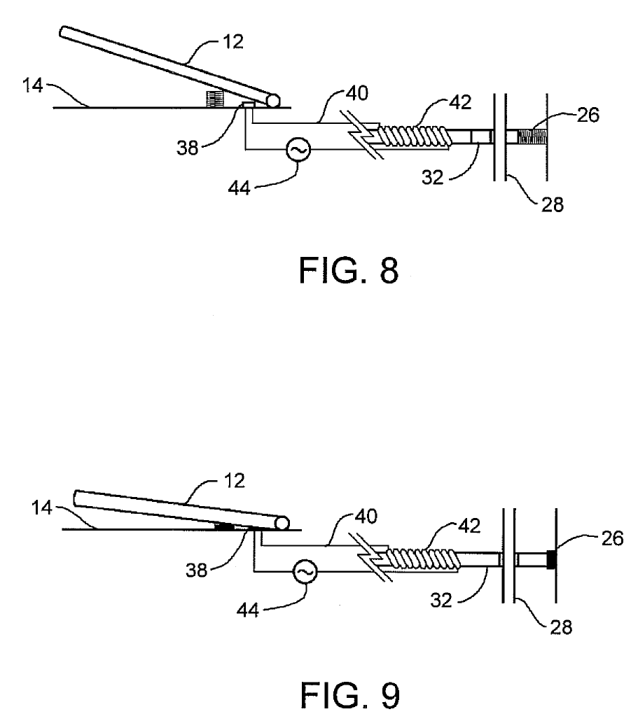

A safety throttle control for an ATV generally identified by reference numeral 10, will now be described with reference to FIG. 1 through 7. An alternative embodiment will be described further on with reference to FIG. 8 through 9.

Structure and Relationship of Parts:

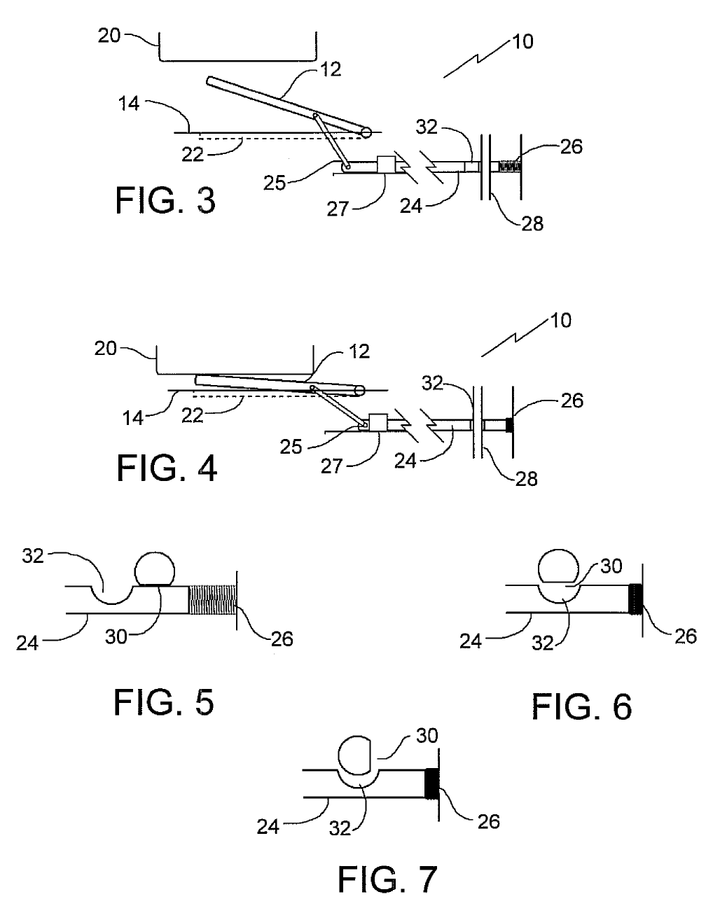

Referring to FIG. 1, safety throttle control 10 includes a pressure activated lever 12 on a handle 14 of an ATV (not shown). Handle 14 of ATV is adjacent to a throttle lever 18. The throttle, generally identified by 23, is made up of throttle lever 18, a throttle trigger 29, a shaft 28 connecting throttle trigger 29 to throttle lever 18, and a throttle cable 36 that runs to the engine. Referring to FIG. 3, pressure activated lever 12 is positioned on handle 14, such that an operator's hand 20 applies pressure to activate lever 12. Referring to FIGS. 1 and 2, as lever 12 is depressed, it may lower into a cavity 22 such that lever 12 becomes flush with handle 14. While lever 12 is depicted as being positioned on the front part of handle 14, it may be positioned in any convenient location that requires the operator to place her hand before operating the ATV. Furthermore, lever 12 may take different forms, such as a button as shown in FIG. 1 or an arm as shown in FIG. 3. An actuator 24 prevents throttle lever 18 from moving from an idling position unless pressure is concurrently applied to pressure activated lever 12. Pressure activated lever 12 is connected to actuate actuator 24 by a linkage 25. The movement of linkage 25 may be stabilized and guided by a guide 27. Actuator 24 has an operative throttle position shown in FIG. 5 and a idle lock position shown in FIG. 6 and 7. Referring to FIG. 1, actuator 24 is biased in the idle lock position by spring 26, such that, in the idle lock position, actuator 24 prevents throttle lever 18 from moving by preventing the rotation of shaft 28. Shaft 28 being blocked by actuator 24 is shown in detail in FIG. 5. As pressure is applied to throttle trigger 29 to rotate shaft 28 to activate throttle lever 18, actuator 24 engages an engagement interface 30 on shaft 28 when in the idle lock position to prevent shaft 28 from rotating. Referring to FIG. 2, in the operative throttle position, actuator 24 has a recess 32 that is positioned adjacent shaft 28 such that accommodates shaft 28, such that shaft 28 is free to rotate. This is shown in detail in FIG. 6 and 7. Once fuel flow to the engine has been increased initially, actuator 24 will not return to the idle lock position until throttle lever 18 returns to the idle position.

Operation:

The operation of safety throttle control 10 as describe above with reference to FIG. 1 through 7 will now be discussed. Referring to FIG. 1, throttle control 10 is shown in the idle lock position, with throttle 23 in the idle position. Referring to FIG. 5, in this position, any attempt to apply pressure to throttle trigger 29 will result in no movement, as engagement interface 30 on shaft 28 is engaged by actuator 24, preventing it from rotating. Referring to FIG. 3, as the operator prepares to depress throttle trigger 29, the operator places their hand 20 on handle 14, which depresses pressure activated lever 12. Referring to FIG. 4, depressing lever 12 causes linkage 25 to actuate actuator 24 from the idle lock position shown in FIG. 3 to the operative throttle position shown in FIG. 4, such that recess 32 is positioned adjacent shaft 28 as shown in FIG. 6. Referring to FIG. 2, the operator is then free to depress throttle trigger 29, which in turn rotates shaft 28 within recess 32 and therefore throttle lever 18. Once throttle trigger 29 has been released, returning throttle 23 to the idle position, if the operator removes pressure from lever 12, spring 26 will cause actuator 24 to return to the idle lock position to lock throttle 23. This is intended to prevent unintended acceleration of the ATV. For example, the throttle trigger 29 may be accidentally bumped when the ATV is idling and the operator is unprepared when loading or unloading the ATV or otherwise. In another example, the operator may lose their grip on handle 14 while riding, such as after encountering an obstacle in the trail. Throttle control 10 prevents the operator from accidentally actuating throttle trigger 29 in this unprepared state while trying to regain their grip on handle 14.

The above apparatus could be designed to be retrofit onto an ATV by replacing the existing handle and throttle with one incorporating safety throttle control 10 described above. This may cause handle 14 to be enlarged, such that a handle of corresponding size would have to be sold for the other handle as well. Alternatively, safety throttle control 10 could be installed at the time of manufacture, in which case it would be possible to take advantage of the hollow inside of handle 14 to house some of the components.

Variations:

The above describes one embodiment of the present invention. It will be understood that there are many variations that would also cause throttle trigger to be in an inoperative idling position, whether it be held immobile, or allowed to move without effect on throttle 23. For example, referring to FIG. 1, actuator 24 may engage other portions of throttle 23, such as throttle lever 18 directly, throttle trigger 29, or the throttle cable 36. Any of these would result in throttle trigger 29 being rendered immobile. Instead of engagement interface 30 and recess 32 to allow or prevent rotation, other means may be used, such as providing a hole that actuator 24 passes through, instead of engaging engagement interface 30. This will also depend on what is being engaged by actuator 24. For example, if actuator 24 merely blocks the rotation of throttle lever 18 in the idle lock position, there may not be a need for any engagement interface or recess. Alternative, the engagement interface may be a hole, with actuator 24 entering the hole (not shown) in throttle lever 18 to prevent rotation. Alternatively, actuator 18 may engage throttle trigger 29 and throttle lever 18 in the operative throttle position such that, in the idle lock position, the movement of throttle trigger 29 will be unrelated to the movement of throttle lever 18. In addition, while the above examples are all mechanical, an electric circuit may also be used. Referring to FIG. 8, pressure activated lever 12 acts on a pressure sensitive switch 38. Alternatively, lever 12 may act as switch 38. Referring to FIG. 9, switch 38 closes a circuit 40, which activates a solenoid 42 to move actuator 24 into the operative throttle position. The power source 44 may be the ATVs electrical system (not shown). It will be understood, however, that the mechanical linkage describe previously is preferred because it would be less expensive to install, and would require less maintenance. Additionally, if there were an electrical failure, actuator 24 could not be moved to the operative throttle position. Those skilled in the art will recognize that there are many ways of moving actuator 24, having actuator 24 lock throttle 23, and many different forms of actuator 24 that would be suitable beyond those describe above and illustrated in the drawings.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope defined in the Claims.

What is claimed is:

1. A safety throttle control for an ATV, comprising:
a switch on a handle of an ATV, the handle of the ATV being adjacent to a throttle lever; and
means for preventing the throttle lever from moving from an idling position unless pressure is concurrently applied to the switch.

2. The safety switch of claim 1, wherein the switch is positioned on a top of the handle, such that a palm of an operators hand applies pressure to the switch.

3. The safety switch of claim 1, wherein the means for preventing the throttle from moving from an idling position is a mechanical means.

4. The safety switch of claim 3, wherein the switch is a lever and the means for preventing the throttle from moving from an idling position is an actuator, the lever actuating the actuator, the actuator having an operative throttle position and a idle lock position, the actuator being biased in the idle lock position, such that, in the idle lock position, the actuator prevents the throttle lever from moving.

5. The safety switch of claim 4, wherein the throttle lever rotates a shaft, in the idle lock position the actuator engaging the shaft to prevent the shaft from rotating, and the actuator having a recess that is positioned adjacent the shaft when the actuator is in the operative throttle position, the recess in the actuator accommodating the shaft and allowing the shaft to rotate.

6. The safety switch of claim 4, wherein the actuator is actuated by a solenoid, the solenoid being controlled by the lever.

7. A safety throttle control for an ATV, comprising:
a pressure activated lever on a handle of an ATV, the handle of the ATV being adjacent to a throttle lever, the lever being positioned on a top of the handle, such that a palm of an operator's hand applies pressure to activate the lever;
an actuator for preventing the throttle from moving from an idling position unless pressure is concurrently applied to the pressure activated lever;
the pressure activated lever actuating the actuator, the actuator having an operative throttle position and an idle lock position, the actuator being biased in the idle lock position, such that, in the idle lock position, the actuator prevents the throttle lever from moving from an idling position; and
the throttle lever rotating a shaft, in the idle lock position the actuator engaging an engagement interface on the shaft to prevent the shaft from rotating, and the actuator having a recess that is positioned adjacent the shaft when the actuator is in the operative throttle position, the recess in the actuator accommodating the shaft and allowing the shaft to rotate.

8. A safety throttle control for an AVT, comprising:
a switch on a handle of an ATV, the handle of the ATV being adjacent to a throttle trigger, the throttle trigger being in an inoperative idling position unless pressure is concurrently applied to the switch and the throttle trigger.
